(19) United States
(12) Patent Application Publication
(10) Pub. No.: US 2026/0121860 A1
(43) Pub. Date: Apr. 30, 2026

(54) METHOD AND SYSTEM FOR TOKEN PUSH-PULL PROVISIONING

(71) Applicant: Visa International Service Association, San Francisco, CA (US)

(72) Inventors: Karthikeyan Palanisamy, Singapore (SG); Dehao Wang, Singapore (SG); Samuel Andrew Mason, Singapore (SG); Nathanael Eduard Posumah, Singapore (SG); Pallavi Amit Lele, Singapore (SG)

(73) Assignee: Visa International Service Association, San Francisco, CA (US)

(21) Appl. No.: 19/483,229

(22) PCT Filed: May 22, 2024
(86) PCT No.: PCT/US2024/030541

§ 371 Date: Nov. 10, 2025

Related U.S. Application Data
(60) Provisional application No. 63/503,575, filed on May 22, 2023.

(51) Int. Cl. H04L 9/32

(52) U.S. Cl. CPC H04L 9/3213

(57) ABSTRACT

A method and system for provisioning credentials is disclosed. The method includes receiving, by a server computer from an authorizing entity computer, a provisioning request message. The provisioning request message can include resource provider identifiers for a set of resource providers and a set of credentials to be associated with the set of resource providers. The method further includes transmitting, by the server computer, a provisioning instruction message to an intermediate computer. The provisioning instruction message can include the resource provider identifiers and credential reference identifiers associated with the set of credentials. The intermediate computer can transmit one or more token request messages to a token service computer, receive tokens corresponding to the credential reference identifiers, and provision the tokens to the resource providers associated with the resource provider identifiers.

### CROSS-REFERENCE TO RELATED APPLICATIONS

This international application claims priority to U.S. Patent Application No. 63/503,575, filed on May 22, 2023, the disclosure of which is herein incorporated by reference in its entirety for all purposes.

### BACKGROUND

Currently, when a user device performs an interaction, the user device can interact using a token that acts as the user's credentials. For example, the user device can provide the token from a digital wallet of the user device to a resource provider to proceed with an interaction. However, this requires the user to transact with the resource provider using the particular device storing the digital wallet. In other cases, the user needs to manually input their credentials directly in the user device. This results in an inefficient interaction for end users and can require additional communications and processing in order to request and provision a token for use in the interaction.

Embodiments of the disclosure address this problem and other problems individually and collectively.

### SUMMARY

One embodiment of the invention is directed to a method comprising: receiving, by a server computer from an authorizing entity computer, a provisioning request message including resource provider identifiers for a set of resource providers and a set of credentials to be associated with the set of resource providers; and transmitting, by the server computer, a provisioning instruction message including the resource provider identifiers and credential reference identifiers associated with the set of credentials to an intermediate computer, where the intermediate computer transmits one or more token request messages including the credential reference identifiers to a token service computer, receives tokens corresponding to the credential reference identifiers, and provisions the tokens to the resource providers associated with the resource provider identifiers.

Another embodiment of the invention can be directed to a server computer configured to perform the above-described method.

Another embodiment of the invention is directed to a method comprising: transmitting, to an authorizing entity computer, a provisioning request message including a credential; receiving, from the authorizing entity computer, a set of resource providers to which the credential can be provisioned; transmitting, to the authorizing entity computer; a subset of resource providers of the set of resource providers, where the authorizing entity computer is configured to initiate, at a server computer and in response to receipt of the subset of resource providers, a process for provisioning the credential to a set of resource provider computers associated with the subset of resource providers; and receiving, from the authorizing entity computer, a provisioning status message indicating successful provisioning of the credential to the subset of resource providers.

Another embodiment of the invention can be directed to a user device configured to perform the above-described method.

These and other embodiments of the invention are described in further detail below, with reference to the Figures and Detailed Description.

### BRIEF DESCRIPTION OF THE DRAWINGS

FIG. 1 shows a block diagram of a system according to an embodiment of the invention.

FIG. 2 shows a block diagram of a server computer of the system according to an embodiment of the invention.

FIG. 3 shows a block diagram of a user device of a system according to an embodiment of the invention.

FIG. 4 shows a flow diagram illustrating a push provisioning process according to an embodiment of the invention.

FIG. 5 shows a flow diagram illustrating another push provisioning process according to an embodiment of the invention.

FIG. 6 shows a block diagram of a process flow illustrating a push provisioning process according to an embodiment of the invention.

FIG. 7 shows a flow diagram illustrating a pull provisioning process using according to an embodiment of the invention.

FIGS. 8A and 8B show illustrations of graphical user interfaces (GUIs) displayed during a push provisioning process according to an embodiment of the invention.

FIG. 9 shows illustrations of GUIs displayed during a push provisioning process according to an embodiment of the invention.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user identifier” can include any piece of data that can identify a user. A user identifier can comprise any suitable alphanumeric string of characters. In some embodiments, the user identifier may be derived from user identifying information. In some embodiments, a user identifier can include an account identifier associated with the user. For example, a user can be associated with an account, which has an account identifier, maintained by an authorizing entity computer.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction can include a transaction interaction, a data transfer interaction, an access interaction, etc.

“Interaction data” can include data related to and/or recorded during an interaction. Interaction data can include an amount, a date, a time, a resource identifier, a resource provider identifier, a user identifier, credentials, and/or additional data relating to an interaction between a user and a resource provider.

A “resource provider” may be an entity that can provide a resource such as goods, services, information, and/or access. Examples of resource providers includes merchants, data providers, transit agencies, governmental entities, venue and dwelling operators, etc. A “merchant” may typically be an entity that engages in transactions and can sell goods or services, or provide access to goods or services.

A “credential” may include any suitable information associated with an account (e.g. a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some 4 embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other information that may be replaced with a substitute value (i.e., token). Tokenization enhances transaction efficiency and security.

A “provisioning request message” may be an electronic message that requests provisioning of a token to an entity. In some embodiments, a provisioning request message is sent to a server computer to request provisioning of a token to an entity. A provisioning request message, according to some embodiments, may comply with International Organization for Standardization (ISO) 8583, which is a standard for systems that exchange electronic transaction information associated with a payment made by a user using a payment device or payment account. The provisioning request message may include a credential that may be associated with a payment device or payment account. A provisioning request message may also include additional data elements corresponding to identification information including, by way of example only: a service code, a CVV (card verification value), a dCVV (dynamic card verification value), a PAN (primary account number or “account number”), a payment token, a username, an expiration date, etc. A provisioning request message may also include recipient information, such as any information associated with an intended recipient of the provisioned token, such as a resource provider identifier, resource provider location, etc., as well as any other information that may be used in identifying the recipient of the token.

A “provisioning instruction message” may be a message generated in response to a provisioning request. In some cases, it may be an electronic message including some or all information received in a provisioning request message (e.g., a credential, identification information, recipient information). The provisioning instruction message may be sent to a computer, such as an intermediate computer, which may be communicatively coupled to a server computer and one or more resource provider computers. A provisioning instruction message, according to some embodiments, may comply with ISO 8583, or other standards for transmission of sensitive information.

A “token request message” may be a message requesting a token. The token may be a payment token provisioned to a resource provider computer and useable in an interaction between a user and a resource provider. A token request message may include a credential, identification information, or recipient information such that a token service computer can provision a token to a resource provider computer.

An “authorizing entity” may be an entity that authorizes a request.

Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

An “issuer” may typically refer to a business entity (e.g., a bank, cloud services provider) that maintains an account for a user. An issuer may also issue credentials (e.g., payment credentials) stored on a user device, such as a cellular telephone, smart card, tablet, or laptop to the consumer.

An “authorizing entity application” may include an application maintained and operated by an entity that authorizes a request. An authorizing entity application may provide standalone user-facing software applications that enable a user to manage credentials associated with the authorizing entity, such as one or more payment credentials.

An “identification and verification (ID&V) method” may be used to authenticate an entity. For example, an ID&V method may be used to authenticate a user prior to providing the user with a list of credentials associated with the user. Examples of ID&V methods may include, but are not limited to, an account verification message, a risk score based on assessment of the primary account number (PAN) and use of one-time password (OTP) by the issuer or its agent to verify the account holder. Exemplary ID&V methods may be performed using information such as a user signature, a password, an offline or online personal identification number (PIN), an offline or online enciphered PIN, a combination of offline PIN and signature, a combination of offline enciphered PIN and signature, user biometrics (e.g. voice recognition, fingerprint matching, etc.), a pattern, a glyph, knowledge-based challenge-responses, hardware tokens (multiple solution options), one time passwords (OTPs) with limited use, software tokens, two-channel authentication processes (e.g., via phone), etc.

The term “verification” and its derivatives may refer to a process that uses information to determine whether an underlying subject is valid under a given set of circumstances. Verification may include any comparison of information to ensure some data or information is correct, valid, accurate, legitimate, and/or in good standing.

A “processor” may include a device that processes something. In some embodiments, a processor can include any suitable data computation device or devices. A processor may include one or more microprocessors working together to accomplish a desired function. The processor may include a CPU including at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may include a non-transitory computer readable medium that stores instructions that can be executed by a processor to implement a desired method. Examples of memories may include one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may include one or more computational apparatuses and may use any of a variety of computing structures, arrangements, and compilations for servicing the requests from one or more client computers.

Embodiments disclosed herein allow for the provisioning of tokens associated with credentials for use during an interaction between a user and a resource provider. In some embodiments, prior to an interaction with a resource provider, a credential can be provisioned to a resource provider computer based on a provisioning request received by an authorizing entity via an authorizing entity application on the user device. The provisioning request can specify a resource provider associated with a resource provider computer to which the user wishes to provision the credential. For example, a token associated with the credential may be “push” provisioned to a resource provider computer. The authorizing entity can communicate with a server computer to initiate a process for generating or obtaining a token based on the credential and provisioning the token to the resource provider computer associated with the resource provider selected by the user.

In other embodiments, a token may be “pull” provisioned to a resource provider computer (e.g., during an interaction with the resource provider), whereby a user can initiate a pull provisioning request to provision a token associated with a credential to the resource provider computer associated with the resource provider involved in the interaction. The server computer may receive a pull provisioning request message and initiate a pull provisioning process to provision a token to the resource provider computer to allow the user to complete the interaction using the token.

Disclosed systems and methods provide a number of advantages over current systems and methods for completing a transaction between entities using a credential. For example, disclosed embodiments facilitate a seamless provisioning experience for a user wishing to provision a credential to a resource provider. The user can either push or pull provision a credential securely at multiple points in the transaction process. For example, the user can push provision a credential prior to engaging in a transaction with a resource provider such that the provisioned credential is ready and available during a subsequent transaction with the resource provider. The user can also provision multiple credentials to multiple resource providers simultaneously, obviating the need for the user to complete repetitive steps to provision multiple credentials to multiple resource providers. Disclosed systems and methods further obviate the need for the user to manually input credential information during a transaction process, as the provisioned credential is already available to the resource provider during the transaction.

It should be understood that the technical advantages of the present invention are not only applicable to payment-based token provisioning systems. In another non-limiting example, an authorizing entity may be a cloud services provider that issues credentials used to access files. Disclosed systems and methods can enable a user to push provision credentials to restricted systems prior to an interaction with the restricted system, such that the credential is available to the restricted system as a provisioned token for use in granting access to the user. The architecture of disclosed systems can further reduce the number of infrastructure updates or modifications required by resource providers (e.g., bank, cloud services provider, etc.) in order to receive provisioned tokens, and thus enable more efficient token provisioning to a wider variety of resource providers.

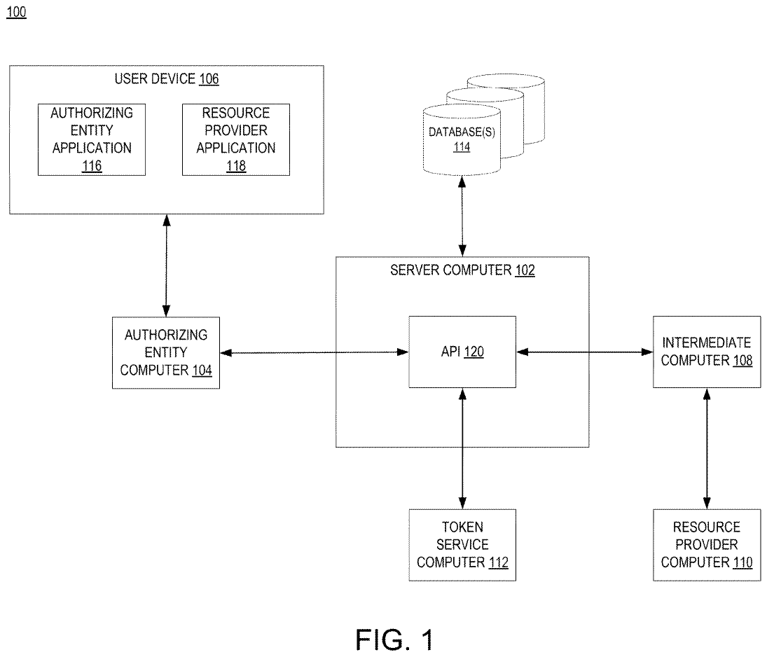

FIG. 1 shows a block diagram of a system 100 for provisioning a token, according to an embodiment of the invention. The system 100 comprises a server computer 102, an authorizing entity computer 104, a user device 106, an intermediate computer 108, a resource provider computer 110, a token service computer 112, and database(s) 114. For simplicity of illustration, a certain number of components are shown in FIG. 1. It is understood, however, that some embodiments may include more than one of each component. In addition, some embodiments may include fewer than or greater than all of the components shown in FIG. 1.

The server computer 102, authorizing entity computer 104, user device 106, intermediate computer 108, resource provider computer 110, and token service computer 112 may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The server computer 102 may be associated with a payment processor, which may be an entity that enables payment processing between a resource provider and a user (e.g., a user associated with the user device 106). The server computer 102 can communicate with the authorizing entity computer 104, user device 106, intermediate computer 108, resource provider computer 110, and token service computer 112, for example, to provision a token associated with a credential of the user to the resource provider, such that the token can be used to complete interactions between the user and the resource provider. In some embodiments, the server computer 102 may include an application programming interface (API) 120 through which the authorizing entity computer 104 and the intermediate computer 108 (or in some embodiments, the resource provider computer 110) can interact with the server computer 102 to provision a token associated with a user to the resource provider computer 110.

The authorizing entity computer 104 can include a computer that can authorize interactions. The authorizing entity computer 104 can issue and manage one or more accounts associated with the user of the user device 106. Managing an account can include authorizing interactions on the account. The authorizing entity computer 104 can also store credentials (e.g., account numbers) associated with various users.

The user device 106 may be a device such as a smart phone, smart watch, wearable device, etc. capable of executing one or more applications stored thereon. The user device 106 may be capable of interacting with the authorizing entity computer 104 (e.g., via the authorizing entity application 116), the server computer 102, and the resource provider computer 110. The user device 106 can, for example, execute an authorizing entity application 116 provided by the authorizing entity computer 104. In other embodiments, the user device 106 can execute a resource provider application 118 provided by the resource provider computer 110. The user device 106 can interact with the authorizing entity computer 104 or the resource provider computer 110 to initiate a push or pull token provisioning request, respectively.

The authorizing entity application 116 can be an application that is operated or provided by an authorizing entity. The authorizing entity application 116 can allow a user to obtain or manage credentials provided by the authorizing entity. For example, in some embodiments, the authorizing entity application 116 can allow a user to manage credentials such as payment instruments (e.g., credit cards) which may be issued by the authorizing entity and which may be used to complete interactions (e.g., transactions). In other embodiments, the credentials provided by the authorizing entity may be used to verify the user for entry or exit to a building or terminal. In yet another embodiment, the authorizing entity application 116 can be used to request or manage credentials associated with an authorizing entity such as a government agency.

The resource provider application 118 can be an application that is operated or provided by a resource provider. The resource provider application 118 can allow a user to obtain a resource for an interaction. For example, in some embodiments, the resource provider application 118 can allow a user to purchase resources, which can be provided to the user of the user device 106 after completion of an interaction (e.g., a transaction). In other embodiments, the resource provider application 118 can control entrance and exit into and from a building or terminal based on the user's credential issued by the authorizing entity. In yet other embodiments, the resource provider application 118 can be an application, that may be used to confirm a user's identity during an interaction (e.g., for the purpose of authorizing access to social security benefits) by using the credential issued by the authorizing entity.

The intermediate computer 108 may be associated with a service provider, which may facilitate interactions with one or more resource providers (e.g., the resource provider computer 110). For example, the service provider can operate a transaction processing platform configured to process transactions with one or more resource providers on behalf of the resource provider. In some embodiments, the intermediate computer 108 can interact with the server computer 102 and resource provider computer 110 to provision a token to the resource provider computer 110 in response to a provisioning request.

The resource provider computer 110 can be a computer or network of computers associated with a resource provider. The resource provider computer 110 can host an e-commerce website associated with the resource provider or can provide, to the user device 106, an application (e.g., resource provider application 118) for facilitating interactions between the user and the resource provider. The resource provider computer 110 can also interact with the server computer 102 directly or indirectly via the intermediate computer 108.

The token service computer 112 can include one or more computers that generate, process, and maintain tokens. For example, the token service computer 112 may include or be in communication with a token database where the generated or obtained tokens are stored. Additionally or alternatively, the token database may maintain one-to-one mapping between a token and a credential represented by the token. In some embodiments, various entities of a tokenization ecosystem may assume the roles of the token service computer 112. For example, the server computer 102 can include the token service computer 112 by implementing the token services.

Database(s) 114 can include one or more databases configured to store token or provisioning data. For example, database(s) 114 can include a routing database, a configuration database, and a cache. The routing database can store routing information associated with the resource provider computer 110 such that a token can be provisioned to the resource provider computer 110 according to the routing information stored in the routing database. The configuration database can store data associated with resource providers and intermediate computers that are able to request or receive tokens associated with credentials issued by the authorizing entity. The cache can cache or store token identifiers associated with provisioned tokens, as well as information indicating to which resource provider the token is provisioned.

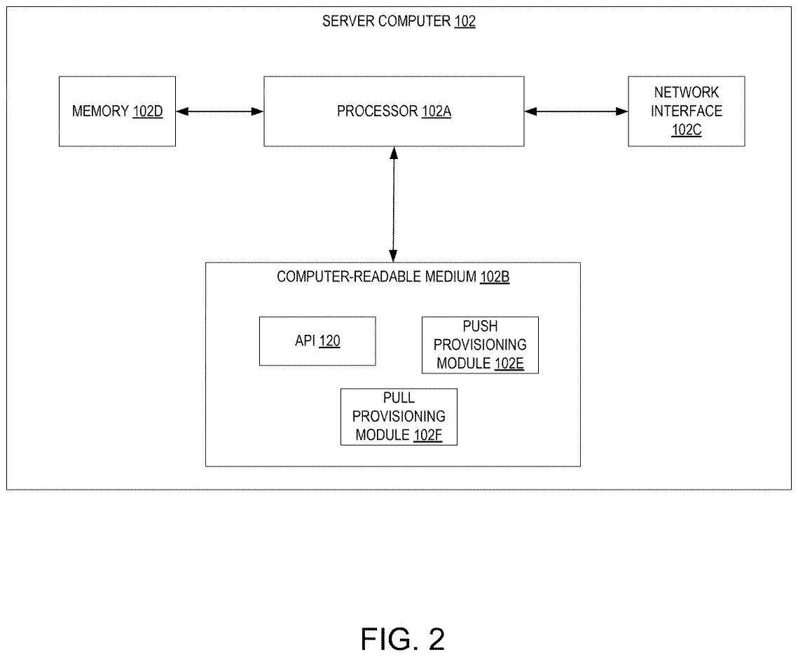

An example of the server computer 102 is shown in FIG. 2. In some embodiments, the server computer 102 can include components configured to execute functionality described herein. For example, the server computer 102 can include a processor 102A, a computer-readable medium 102B, a network interface 102C, and a memory 102D.

The computer readable medium 102B may include code, executable by the processor 102A for implementing the methods discussed herein. For example, the computer-readable medium 102B may include code, executable by the processor 102A, for performing a method including: receiving, from an authorizing entity computer, a provisioning request message including resource provider identifiers for a set of resource providers and a set of credentials to be associated with the set of resource providers; and transmitting a provisioning instruction message comprising the resource provider identifiers and credential reference identifiers associated with the set of credentials to an intermediate computer, where the intermediate computer transmits one or more token request messages including the credential reference identifiers to a token service computer, receives tokens corresponding to the credential reference identifiers, and provisions the tokens to the resource providers associated with the resource provider identifiers.

The API 120 can be configured to facilitate interactions, via the network interface 102C, between the server computer 102 and external systems, such as the authorizing entity computer 104, the intermediate computer 108, and the resource provider computer 110. The API 120 can, for example, receive a provisioning request message, e.g., from the authorizing entity computer 104, and route the provisioning request message to the appropriate component or module for handling the request. For example, a push provisioning request message can be routed to the push provisioning module 102E, and a pull provisioning request message can be routed to the pull provisioning module 102F.

The push provisioning module 102E can be configured to execute a process for obtaining a token associated with a user credential and provisioning the token to the resource provider computer 110. In some embodiments, the push provisioning module 102E can interact with the token service computer 112 to obtain the token associated with the user credential. The push provisioning module 102E can obtain the token and push the token to the resource provider computer 110 in response to a push provisioning request initiated by a user using user device 106.

The pull provisioning module 102F can be configured to execute a process for retrieving a token associated with a user credential and provisioning the token to the resource provider computer 110. In some embodiments, the pull provisioning module 102F can interact with database(s) 114 to retrieve a token identifier pointing to a previously obtained token associated with a credential of the user. The pull provisioning module 102F can provision the token to the resource provider computer 110 in response to a pull provisioning request initiated by a user using user device 106.

The network interface 102C may include an interface that can allow the server computer 102 to communicate with external computers. The network interface 102C may enable the server computer 102 to communicate data to and from another device (e.g., the authorizing entity computer 104, the intermediate computer 108, the resource provider computer 110, the token service computer 112, etc.). Some examples of the network interface 102C may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 102C may include Wi-Fi™. Data transferred via the network interface 102C may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 102C and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The memory 102D can be used to store data and code. The memory 102D may be coupled to the processor 102A internally or externally (e.g., cloud based data storage), and may include any combination of volatile and/or non-volatile memory, such as RAM, DRAM, ROM, flash, or any other suitable memory device. For example, the memory 102D can store interaction data, tokens, credentials, etc.

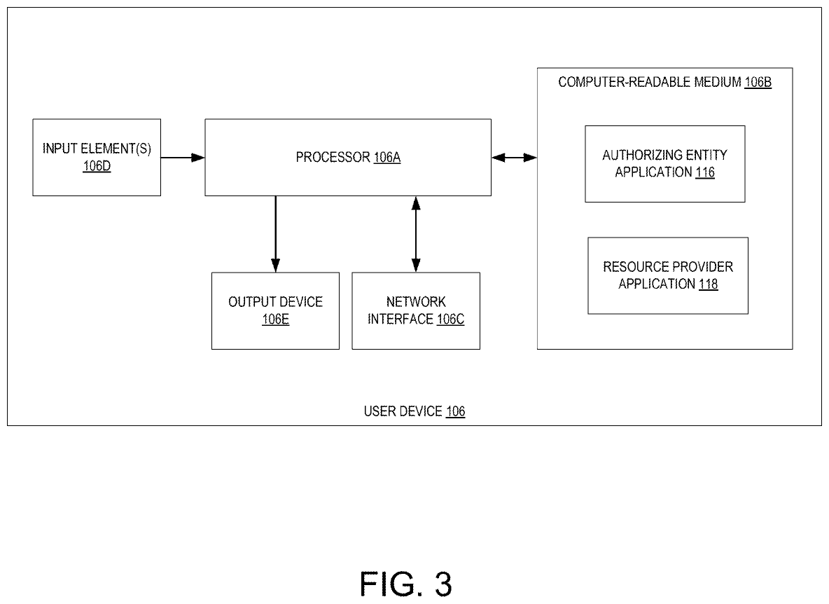

An example of a user device 106 is shown in FIG. 3. In some embodiments, the user device 106 can include components configured to execute the functionality described herein. For example, the user device 106 can include a processor 106A, a computer-readable medium 106B, a network interface 106C, input elements 106D, and an output device 106E.

The computer readable medium 106B may include code, executable by the processor 106A for implementing the methods discussed herein. For example, the computer-readable medium 106B may include code, executable by the processor 106A, for performing a method including: transmitting, to an authorizing entity computer, a provisioning request message including a credential; receiving, from the authorizing entity computer, a set of resource providers to which the credential can be provisioned; transmitting, to the authorizing entity computer, a subset of resource providers of the set of resource providers, where the authorizing entity computer is configured to initiate, at a server computer and in response to receipt of the subset of resource providers, a process for provisioning the credential to a set of resource provider computers associated with the subset of resource providers; and receiving, from the authorizing entity computer, a provisioning status message indicating successful provisioning of the credential to the subset of resource providers.

The authorizing entity application 116 may be an application stored on the user device 106 and provided by the authorizing entity computer 104. The authorizing entity application 116 can include functionality to enable a user to request and manage credentials issued by the authorizing entity. For example, the user can, via the authorizing entity application 116 request that an issued credential be provisioned to a resource provider, e.g., to the resource provider computer 110.

The resource provider application 118 may be an application stored on the user device 106 and provided by the resource provider computer 110. The resource provider application 118 can include functionality to enable a user to engage in an interaction with the resource provider. During the interaction and via the resource provider application 118, the user can request that a credential be provisioned to the resource provider computer 110 for use in completing the interaction.

The network interface 106C may include an interface that can allow the user device 106 to communicate with external computers. The network interface 106C may enable the user device 106 to communicate data to and from another device (e.g., the authorizing entity computer 104 or the resource provider computer 110). Some examples of the network interface 106C may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 106C may include Wi-Fi™. Data transferred via the network interface 106C may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 106C and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Input element(s) 106D can be components of the user device 106 configured to receive input. For example, input element(s) 106D can include buttons, touchscreens, keyboards, and the like. The user associated with the user device 106 can interact with the user device 106 using input element(s) 106. For example, the user may interact with a touchscreen to perform operations using the authorizing entity application 116 or the resource provider application 118.

Output device 106F can be a component of the user device 106 configured to output information. For example, output element 106F can be a speaker or screen. In some embodiments the output device 106F may be combined with an input element 106E, such as a touchscreen display. The output device 106F can, in the example of a touchscreen, display one or more graphical user interfaces (GUIs) configured to enable a user to interact with the authorizing entity application 116 or the resource provider application 118.

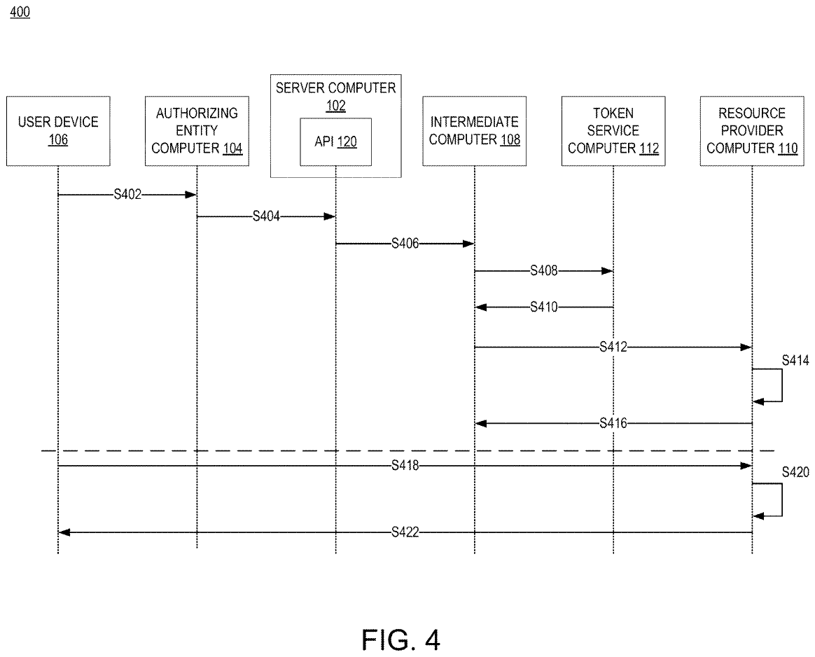

FIG. 4 is a process flow diagram of an exemplary process 400 for push provisioning a token. The process 400 can enable a user to request a token associated with a credential to be provisioned to the resource provider computer 110.

At step S402, the process 400 can include transmitting, from the user device 106 to the authorizing entity computer 104, a selection of a credential to be provisioned and a selection of a resource provider to which the credential is to be provisioned. For example, a user may select a credential issued by the authorizing entity via the authorizing entity application 116. The user can request that the credential be provisioned to the resource provider such that, in a subsequent interaction with the resource provider, the credential is automatically provided as an option with which to complete the interaction.

At step S404, the process 400 can include transmitting, from the authorizing entity computer 104 to the server computer 102, a provisioning request message including the credential and resource provider information, such as an indication of the selected resource provider (e.g., a resource provider name or identifier). The provisioning request message can be received at the server computer 102 via the API 120, which is configured to receive inputs from external systems (e.g., the authorizing entity computer 104) and route the provisioning request message to the appropriate component of the server computer 102 for execution of the request.

In some embodiments, the server computer 102 can generate a credential reference identifier. For example, the server computer 102 can encrypt the credential to generate the credential reference identifier. In one embodiment, the credential can be a PAN associated with a payment instrument and the server computer 102 can generate the credential reference identifier by encrypting the PAN.

At step S406, the process 400 can include transmitting, from the server computer 102, the credential reference identifier and resource provider information to the intermediate computer 108. The intermediate computer 108 can be associated with a service provider configured to process or manage transactions associated with one or more resource providers. The intermediate computer 108 can be associated with a service provider managing transactions for the resource provider identified by the resource provider information.

At step S408, the process 400 can include generating, by the intermediate computer 108, a token request message and transmitting the token request message to the token service computer 112. The token request message can include the credential reference identifier. The token service computer 112 can generate or obtain a token based on the credential reference identifier. In some embodiments, the token service computer 112 can decrypt the credential reference identifier to retrieve the credential and generate the token using the credential.

At step S410, the process 400 can include transmitting, from the token service computer 112 to the intermediate computer 108, the generated or obtained token.

At step S412, the process 400 can include transmitting, from the intermediate computer 108 to the resource provider computer 110, the token. The resource provider computer 110 can, in some embodiments, receive multiple tokens from the token service computer 112 (e.g., tokens associated with different credentials). For example, a user can request to provision multiple tokens to one or more resource providers.

At step S414, the process 400 can include storing, by the resource computer 110, the token received from the intermediate computer 108. For example, the resource provider computer 110 can maintain a database storing tokens associated with users, such that, when interacting with the resource provider (e.g., via a website or application), a user can complete the interaction using the stored token as described below.

In some embodiments, at step S416, the resource computer 110 can transmit a confirmation message to the intermediate computer 108 that the token was successfully received and stored. In some embodiments, in turn, the confirmation message can be transmitted by the intermediate computer 108 to the server computer 102 and then to the user device 106 to notify the user of the successful provisioning.

Once the token is successfully provisioned to the resource provider computer 110, the user can use the token in an interaction with the resource provider. For example, at step S418, the process 400 can include transmitting a request to complete a transaction from the user device 106 to the resource provider computer 110. The request can be generated, for example, as part of a check out process completed in the resource provider application 118. The request can indicate that the user wishes to complete the transaction using the previously provisioned token.

At step S420, the process 400 can include retrieving, by the resource provider computer 110, the stored token. The retrieved token can then be used to complete the transaction. For example, the resource provider computer 110 can provide the token during a payment process with a payment processing system. In some embodiments, the payment processing system may be a component of the server computer 102.

At step S422, the process 400 can include transmitting, by the resource provider computer 110 to the user device 106, a message indicating the transaction has been completed. For example, the resource provider computer 110 can transmit a message to cause the resource provider application 118 to display a message to the user via the user device 106.

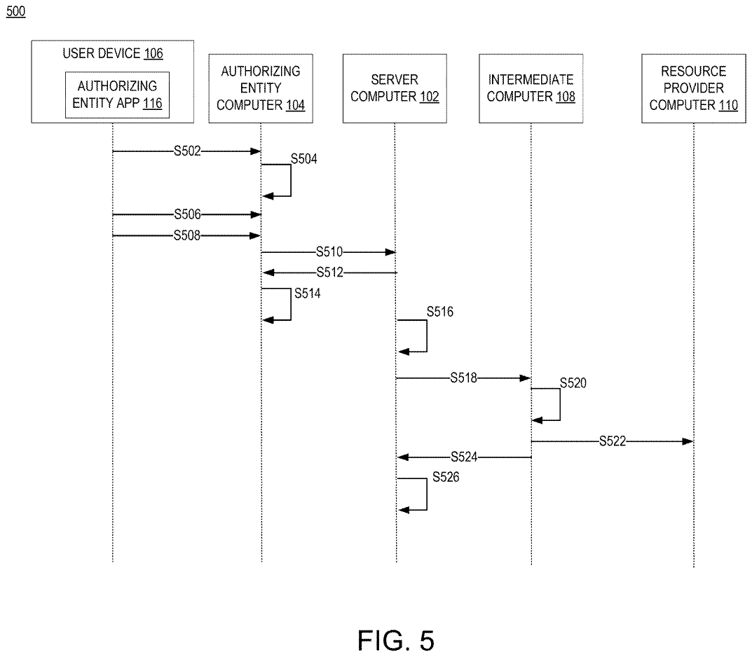

FIG. 5 is a process flow diagram of another exemplary process 500 for push provisioning a token. The process 500 can enable a user to request a token associated with a credential to be provisioned to the resource provider computer 110.

At step S502, the process 500 can include transmitting, from the user device 106 to the authorizing entity computer 104, a message requesting that a selected credential be provisioned. For example, the user of the user device 106 can interact with the authorizing entity through the authorizing entity application 116, which can be used to manage credentials issued by the authorizing entity. The user can select from a list of credentials to provision. Upon receiving the selection in the authorizing entity application 116, the user device 106 can transmit a message including the selected credential to the authorizing entity computer 104.

At step S504, the process 500 can include querying, by the authorizing entity computer 104, a database storing information associated with resource providers capable of receiving a provisioned token associated with the credential. For example, the authorizing entity computer 104 can determine a type of the credential and retrieve records associated with resource providers who can be provisioned with tokens associated with that type of credential. In some embodiments, the database can store resource providers who are enrolled with the authorizing entity, or with the entity associated with the server computer 102, and are capable of receiving a push-provisioned token. The authorizing entity computer 104 can transmit the list, e.g., as a flat file or other file type) to the user device 106.

At step S506, the process 500 can include transmitting, from the user device 106 to the authorizing entity computer 104, a selection of a resource provider from the received list of resource providers. In some embodiments, the user may select a subset of resource providers from the list of resource providers. The authorizing entity application 116 can cause the user device 106 to display a GUI including a selectable list of the resource providers capable of being provisioned with a token associated with the credential. In some embodiments, the user device 106 can transmit a message indicating a resource name or resource identifier associated with the selected resource.

In some embodiments, at step S508, the process 500 can include receiving confirmation via the user device 106 for provisioning the selected credential to the selected resource provider. For example, before proceeding, the authorizing entity application 116 can display a GUI including the selected credential and selected resource provider such that the user may provide affirmative confirmation. In some embodiments, the user may be prompted to verify or confirm their identity through an authentication process before initiating the push provisioning of the credential.

At step S510, the process 500 can include receiving, by the authorizing entity computer 104, the confirmation of the selected credential and selected resource provider and can generate a provisioning request message. The provisioning request message can include the credential and resource provider information identifying the selected resource provider (e.g., a resource provider name or unique identifier). At step S510, the process 500 can further include transmitting the provisioning request message from the authorizing entity computer 104 to the server computer 102.

The server computer 102 can receive the provisioning request message and generate a request identifier associated with the provisioning request. The request identifier can be used, for example, to track information associated with the request, such as a provisioning status. Then, at step S512, the process 500 can include transmitting a message including the request identifier from the server computer 102 to the authorizing entity computer 104.

At step S514, the process 500 can include storing, by the authorizing entity computer 104, the received request identifier. For example, the authorizing entity computer 104 can maintain a cache storing information associated with provisioning requests. Information associated with a provisioning request can include a user identifier, an identifier associated with the credential selected for provisioning, and information associated with the selected resource provider.

At step S516, the process 500 can include asynchronously generating, by the server computer 102, a transaction record for the provisioning request. The transaction record can include, for example, the request identifier, the user identifier, an identifier of the selected credential, an identifier of the selected resource provider, and a provisioning status. In some embodiments, the server computer 102 can include a provisioning database (e.g., a database 114) configured to store and maintain records associated with pending and completed provisioning requests. In some embodiments, the server computer 102 can also store the credential in a secure database or cache such that the credential can be retrieved during a pull-provisioning process. In other embodiments, the server computer 102 can asynchronously record a provisioning record including the credential in the provisioning database.

In some embodiments, at step S516, the process 500 can further include transmitting, by the server computer 102 to the token service computer 112, a token request message. The token request message can include the credential or a non-sensitive credential reference identifier. The server computer 102 can receive a token from the token service computer 112 and transmit the token to the intermediate computer 108 to then be provisioned to the resource provider computer 110 associated with the resource provider selected by the user for provisioning the credential.

In other embodiments, at step S518, the process 500 can include transmitting, from the server computer 102 to the intermediate computer 108, a provisioning instruction message. The provisioning instruction message can include a credential reference identifier, generated by the server computer 102 based on the credential, and a resource provider identifier associated with the selected resource. The provisioning instruction message can be configured to trigger the intermediate computer to 108 to generate a token request message. As in step S516, the token request message can include the credential reference identifier. In some embodiments, the token request message can also include the resource provider identifier.

At step S520, the process 500 can include generating or obtaining, by the intermediate computer 108, the token associated with the selected credential. For example, the intermediate computer 108 can transmit the token request message to the token service computer 112. The token service computer 112 can, for example, decrypt the credential reference identifier to retrieve the credential and tokenize the credential. The token service computer 112 can then transmit the generated token to the intermediate computer 108. In some embodiments, the token can be obtained from a token pool or token store.

At step S522, the process 500 can include provisioning, by the intermediate computer 108, the token to the resource provider computer 110 associated with the selected resource provider. Thus, when interacting with the resource provider via the resource provider application 118, the user will be provided with the option to complete a transaction with the provisioned credential.

Simultaneously or in tandem, the process 500 can include step S524 for transmitting a provisioning status message from the intermediate computer 108 to the server computer 102. The provisioning status message can include a token provisioning result, such as a status of the push provisioning (e.g., success or failure) and can include the request identifier associated with the provisioning request.

At step S526, the process 500 can include receiving, by the server computer 102, the provisioning status message and updating the request record with the provisioning status. For example, the server computer 102 can update a provisioning record in the provisioning database (e.g., database(s) 114) with the provisioning status based on the token provisioning result. In some embodiments, the authorizing entity computer 104 can interact with the server computer 102 via the API 120 to retrieve the status of the provisioning request. The authorizing entity computer 104 may then provide the provisioning status to the user device 106 via the authorizing entity application 114.

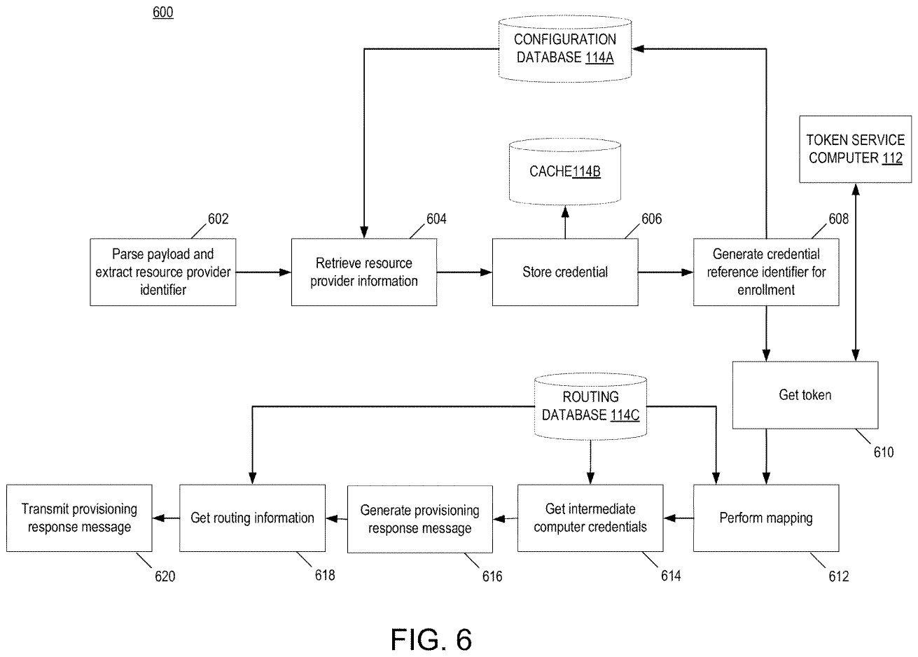

FIG. 6 is an illustration of a process 600 executed by the server computer 102 as part of a push provisioning process (e.g., process 400 or process 500). Process 600 can be executed by one or more components of the server computer 102 such as the API 120 and the push provisioning module 102E.

Process 600 can be initiated at the server computer 102 upon receipt of a provisioning request from the authorizing entity computer 104. The provisioning request can include a credential and a resource provider to which the credential is to be provisioned. In some embodiments, the API 120 can receive the provisioning request from the authorizing entity computer 104 to determine a template data format. The template data format can indicate that the request is a push provisioning request. Based on that determination, the API 120 can route the provisioning request to an enrollment service of the server computer 102, e.g., the push provisioning module 102E.

At block 602, the push provisioning module 102E can parse the payload of the request to extract resource provider information, such as a resource provider identifier. The resource provider identifier can be, for example, a unique identifier received by the resource provider during enrollment for push provisioning. In some embodiments, the push provisioning module 102E can verify the resource provider identifier to determine if the resource provider is enrolled for receiving push-provisioned tokens. If the resource provider is not enrolled, the push provisioning module 102E can return an error message to be transmitted to the authorizing entity computer 104 via the API 120. In some embodiments, the payload can specify a set of resource providers.

The push provisioning module 102E may determine that a first resource provider of the set of resource providers is not enrolled and may transmit, to the authorizing entity computer 104, an error message indicating the enrollment status of the resource provider.

In some embodiments, resource providers can be enrolled, or onboarded, prior to the execution of process 600. For example, the server computer 102 can receive an onboarding request message from the intermediate computer 108. The onboarding request message can include resource provider identifiers associated with a set of resource providers to be onboarded to the system 100. The server computer 102 can onboard the resource providers by storing the associated resource provider identifiers in a configuration database 114A. In some embodiments, during on boarding, the server computer can receive routing or address information associated with the resource providers and can store the routing or address information in a routing database 114C.

Returning to process 600, based on the resource provider identifier, at block 604, the push provisioning module 102E can query a configuration database 114A to retrieve resource provider information. The configuration database 114A can be one of database(s) 114 and can store information associated with enrolled resource providers. In some embodiments, the configuration database 114A can store configuration data associated with service providers (e.g., the service provider managing the intermediate computer 108). For example, configuration data can include mapping data that indicates which service provider is associated with a given resource provider and vice versa.

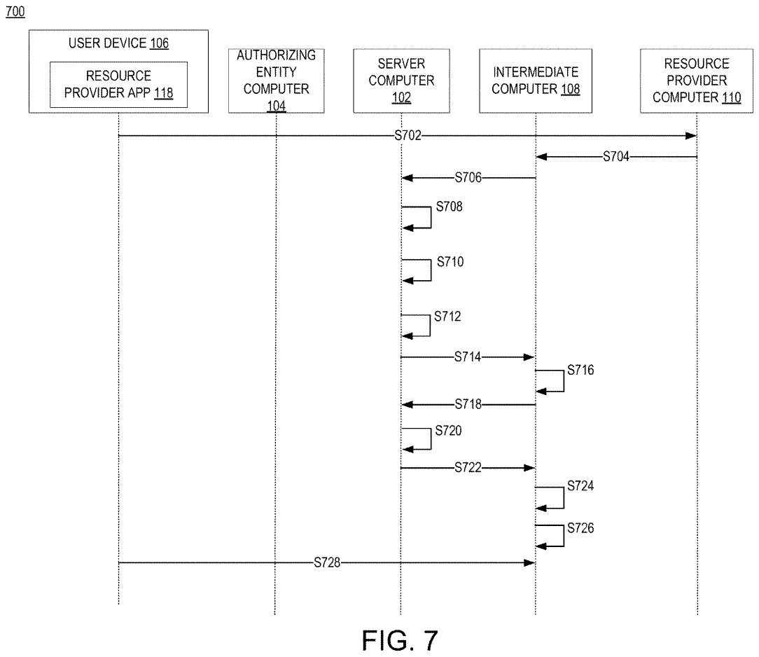

In some embodiments, at block 606, the process 600 can include storing the credential received in the push provisioning request in a cache 114B. The cache 114B can be a database of database(s) 114 and can be configured to store user credentials that have been requested to be provisioned. The cache 114B can, for example, be accessible at a later time during a pull provisioning process (e.g., a process as explained with reference to FIG. 7) such that the server computer 102 can receive a pull provisioning message identifying a user and can retrieve, from the cache 114B, credentials associated with the user based on a user identifier (e.g., a name or account number). In some embodiments, the cache 114B can store encrypted credentials.

At block 608, the push provisioning module 102E can generate a credential reference identifier for the credential received in the push provisioning request. In some embodiments, the credential reference identifier can be an encrypted version of the credential. In other embodiments, the credential reference identifier can be generated by applying one or more transformations or algorithms to the credential such that the credential reference identifier is a non-sensitive reference to the credential. In some embodiments, at block 608, the push provisioning module 102E can also store provisioning request information in the configuration database 114A such that service providers and resource providers can be associated with active or completed provisioning requests.

At block 610, the push provisioning module 102E can generate a token request message and transmit the token request message to the token service computer 112. The token request message can include the credential reference identifier and can be configured to cause the token service computer 112 to generate or obtain a token based on the credential reference identifier. In some embodiments, when the credential reference identifier is an encrypted credential, the token service computer 112 can decrypt the credential reference identifier to obtain the credential and can generate the token based on the credential. In other embodiments, the token is generated based on the credential reference identifier. The token service computer 112 can then transmit a responsive message to the server computer 102 including the generated token as a payload.

At block 612, the push provisioning module 102E can perform mapping based on the resource provider identifier received in the provisioning request. For example, the push provisioning module 102E can query a routing database 114C to identify the service provider (e.g., the entity managing the intermediate computer 108) associated with the resource provider to which the credential is to be provisioned. In some embodiments, a service provider may be associated with multiple resource providers, such that the intermediate computer 108 can provision tokens to multiple resource provider computers.

The routing database 114C can be a database of database(s) 114. For example, the routing database 114C can store information associated with service providers and with resource providers. The routing database 114C can store a mapping of which service providers are associated with which resource providers and vice versa. The routing database 114C can additionally store routing or address information associated with the service providers and resource providers. The routing information can include, for example, a webhook associated with a resource provider that can be used by the API 120 to route the generated token to the appropriate resource provider computer.

At block 614, the push provisioning module 102E can verify the intermediate computer 108 based on the service provider information retrieved from the routing database 114C. For example, the push provisioning module 102E can retrieve service provider information from the routing database 114C. The service provider information can include an identifier of the intermediate computer 108, such as an IP address, that can be used to verify the intermediate computer 108 prior to transmitting the token. In some embodiments, the push provisioning module 102E may interact with an authorization service computer to verify the intermediate computer 108. In other embodiments, the intermediate computer 108 may interact with an authorization service computer, which can verify the intermediate computer 108 and can transmit a message indicating successful verification to the server computer 102.

At block 616, the push provisioning module 102E can generate a provisioning response message. The provisioning response message can have a payload including the generated token and other information associated with the provisioning request, such as the request identifier, the user identifier, the resource provider identifier, a token status (e.g., success or failure), and the like. In some embodiments, the payload of the provisioning response message can be encrypted or otherwise secured.

At block 618, the push provisioning module 102E can retrieve resource provider routing information from the routing database 114C. As discussed above, the routing information can be a webhook, or can be other address or location information configured to route a message to the resource provider computer 110. For example, a webhook associated with a resource provider can be based on resource provider connection details and can define an address of the resource provider (e.g., a digital address or location). In some embodiments, the routing information can be used to transmit the provisioning response message to the intermediate computer 108, which can forward the provisioning response message to the appropriate resource provider computer (e.g., resource provider computer 110). In other embodiments, the server computer 102 can use the routing information to transmit the provisioning response message directly to the resource provider computer 110.

At block 620, the push provisioning module 102E can transmit the provisioning response message, directly or indirectly, to the resource provider computer 110. In some embodiments, the provisioning response message transmission can be handled by the API 120, which can parse the provisioning response message to retrieve the routing information and use the routing information to direct the provisioning response message to the intermediate computer 108 or the resource provider computer 110. In some embodiments, the API 120 can include a forward proxy service configured to parse the provisioning response message and direct the provisioning response message to the appropriate destination.

An exemplary process 700 for pull provisioning a token is illustrated in FIG. 7. The process 700 can be executed using one or more components of the system 100.

At step S702, the process 700 can include initiating, by the user device 106, a transaction with the resource provider computer 110. The transaction can be initiated, for example, through user interaction with the resource provider application 118 stored on the user device 106. In some embodiments, the transaction can be an exchange of funds for goods or services.

At step S704, the process 700 can include transmitting, from the resource provider computer 110 to the intermediate computer 108, a transaction message. The transaction message can include details of the transaction between the user and the resource provider and can be configured to cause the intermediate computer 108 to initiate a process for completing the transaction. For example, the intermediate computer 108 may be configured to handle completion of transactions involving the resource provider computer 110 on behalf of the resource provider computer 110.

At step S706, the process 700 can include transmitting, from the intermediate computer 108 to the server computer 102, a pull provisioning request message. The pull provisioning request message can include a user identifier associated with the user of the user device 106 (e.g., a name, a phone number, an email address, and the like). In some embodiments, the pull provisioning request message can also include an authorizing entity identifier. The authorizing entity identifier can, for example, be associated with an authorizing entity whose issued credentials are accepted by the service provider managing the intermediate computer 108 or by the resource provider.

At step S708, the process 700 can include querying, by the server computer 102, a database to retrieve a set of credentials associated with the user based on the user identifier. For example, the pull provisioning module 102F of the server computer 102 can query the cache 114B to retrieve a set of credentials associated with the user based on the user identifier. In some embodiments, the retrieved set of credentials can be associated with credentials that have been previously push provisioned to resource provider computers by the user. In some embodiments, credential reference identifiers associated with the set of credentials are retrieved from a database storing credential reference identifiers associated with enrolled, or previously provisioned, credentials. In some embodiments, the cache 114 can store credential reference identifiers, rather than credentials. For example, rather than a set of credentials, the server computer 102 may retrieve a set of credential reference identifiers from the cache 114B.

At step S710, the process 700 can include filtering, by the server computer 102, the retrieved set of credentials based on the authorizing entity identifier received in the pull provisioning request message. For example, the pull provisioning module 102F can apply a filter to the set of credentials or, in some embodiments, the set of credential reference identifiers, to remove credentials associated with authorizing entity's whose credentials are not accepted by the service provider or resource provider.

At step S712, the process 700 can include initiating, by the server computer 102, a process for verifying the user. The verification process can include selecting a credential of the filtered set of credentials either randomly or using a selection algorithm to sue as a basis for user verification. The pull provisioning module 102F can use the credential reference identifier associated with the selected credential to trigger an identity and verification (ID&V) process.

At step S714, the process 700 can include transmitting, from the server computer 102 to the intermediate computer 108, an ID&V message. The ID&V message can be configured to cause the intermediate computer 108, via the resource provider application 118, to interact with the user to authenticate the user. For example, the intermediate computer 108 can transmit a one-time password (OTP) to the user device 106 (e.g., in an email or as an SMS message). In some embodiments, the resource provider application 118 can prompt the user to enter biometric information or password information.

At step S716, the process 700 can include receiving, at the intermediate computer 108 via the resource provider application 118, authentication information. As discussed above, the authentication information can be an OTP, biometric information, or a password provided by the user via user device 106.

At step S718, the process 700 can include transmitting, from the intermediate computer 108 to the server computer 102, the authentication information. In some embodiments, the authentication information can be encrypted at the user device 106 prior to transmission to the intermediate computer 108.

At step S720, the process 700 can include completing, by the server computer 102, the verification process. For example, the server computer 102 can decrypt and validate the authentication information. In some embodiments, the server computer 102 can interact with an authentication service computer or an ID&V service computer to verify the user based on the authentication information.

In response to the user being successfully verified, at step S722, the process 700 can include transmitting, by the server computer 102 to the intermediate computer 108, the filtered set of credentials. In some embodiments, the server computer 102 transmits a list of credential reference identifiers associated with the filtered set of credentials.

At step S724, the process 700 can include rendering, by the intermediate computer 108, a GUI configured to display a selectable list of the filtered set of credentials to the user. For example, the GUI can be displayed by the user device 106 to enable the user to select one or more of the listed credentials for provisioning via the resource provider application 118.

At step S726, the process 700 can include receiving, by the intermediate computer 108, a set of selected credentials and pull provisioning the set of selected credentials to the resource provider computer 110. For example, the intermediate computer 108 can interact with the token service computer 112 by transmitting a token request message to the token service computer 112 to obtain tokens associated with the set of selected credentials. In other embodiments, the intermediate computer 108 can transmit a pull provisioning instruction message to the server computer 102, where the pull provisioning instruction message includes a listing of the set of selected credentials. The server computer 102 can then interact with the token service computer 112 to obtain the tokens associated with the set of selected credentials. As discussed above, the server computer 102 can then retrieve routing information from the routing database 114C and transmit the tokens to the intermediate computer 108 or the resource provider 110 based on the routing information.

Once the tokens associated with the set of selected credentials are provisioned to the resource provider computer 110, the user device 106, via the resource provider application 118, may display a GUI through which the user can select one of the provisioned set of credentials with which to complete the transaction. At step S730, the process 700 can include transmitting, from the user device 106 to the intermediate computer 108, the selection of the credential. The intermediate computer 108 may then complete the transaction on behalf of the resource provider computer 110 using the provisioned token associated with the selected credential. In some embodiments, the intermediate computer 108 may further interact with the authorizing entity computer 104 and the server computer 102 to complete the transaction. In other embodiments, the indication of the selected credential may be transmitted directly from the user device 106 to the resource provider computer 110, such that the resource provider computer 110 completes the transaction using the provisioned token associated with the selected credential.

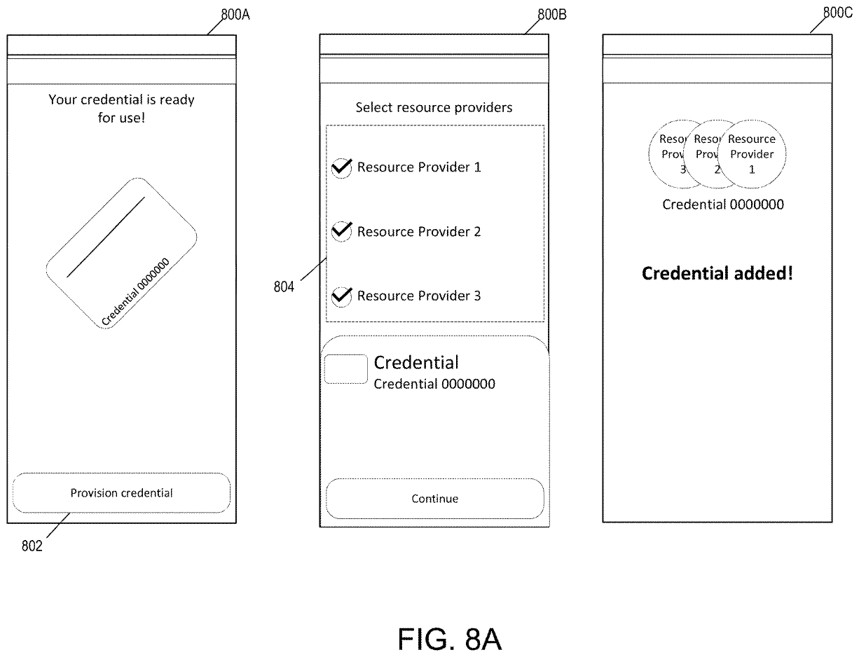

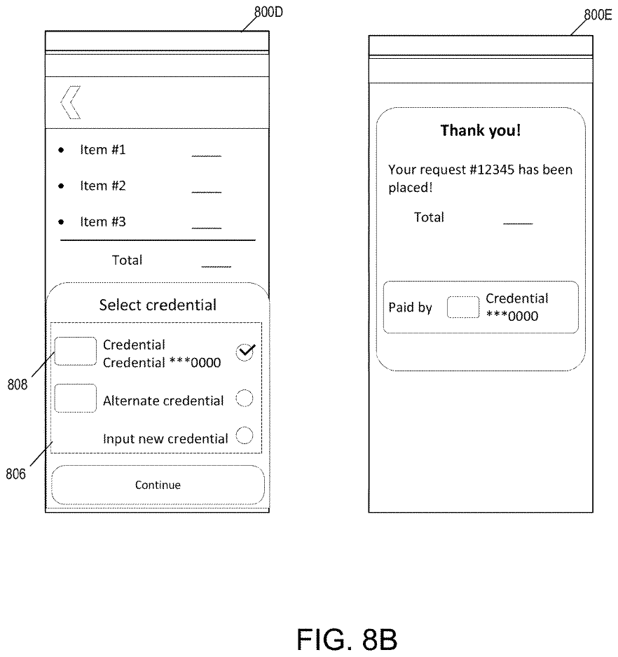

FIGS. 8A and 8B provide illustrations of exemplary GUIs displayed by a user device 106 during a process for push provisioning a token to a resource provider computer 110. GUIs 800A-800E may be displayed via an output device 106E of the user device 106. GUIs 800A-800C may be generated and displayed by the authorizing entity application 116 stored on the user device 106. GUIs 800D and 800E may be generated and displayed by the resource provider application 118 stored on the user device 106.

The GUI 800A, shown in FIG. 8A, may be displayed to a user in response to the user obtaining a credential issued by the authorizing entity associated with the authorizing entity computer 104. Once the credential is issued, the user can select (e.g., via a button 802 or other input field) to provision the credential to one or more resource providers.

The GUI 800B may display a selectable list 804 of resource providers capable of receiving a provisioned token associated with a credential issued by the authorizing entity. In some embodiments, the set of resource providers displayed in the list can be retrieved by the authorizing entity computer 104 from the server computer 102, which maintains a database of enrolled resource providers. As discussed above, the server computer 102 can query an enrollment database to retrieve information associated with enrolled resource providers. In some embodiments, the enrollment database can also store information associated with offers provided to users by resource provider or by the service provider associated with the resource provider as incentive for provisioning credentials to the resource provider. The server computer 102 can retrieve the offer information and transmit the offer information to the authorizing entity computer 104 for display to the user via GUI 800B.

The user can select a set of resource providers displayed via GUI 800B and can select to continue the provisioning process to begin the push provisioning process. On the back end, the authorizing entity computer 104, the server computer 102, the token service computer 112, the intermediate computer 108, and the resource provider computer 110 can communicate to push provision a token associated with the credential to the selected resource providers. For example, transmission of a selection of resource providers from the user device 106 to the authorizing entity computer 104 can initiate a push provisioning process such as process 400 or process 500 described with reference to FIGS. 4 and 5, respectively.

Once the credential is provisioned, the user can execute a transaction using the provisioned credential as illustrated in FIG. 8B through GUIs 800D and 800E. For example, during a transaction conducted via the resource provider application 118, the user can be prompted, via GUI 800D, to select a credential with which to complete the transaction. The list of available credentials 806 can be prepopulated to include the provisioned credential 808 as a selectable option. The user can then select the previously provisioned credential and continue to complete the transaction.

Upon receipt of the selected credential, the resource provider computer 110 can use the token received during the push provisioning process to complete the transaction. Thus, the user can complete the transaction with the provisioned credential without having to input credential information during the transaction process. Upon successful completion of the transaction using the provisioned token, the resource provider application 118 can be configured to display GUI 800E notifying the user of the successful transaction.

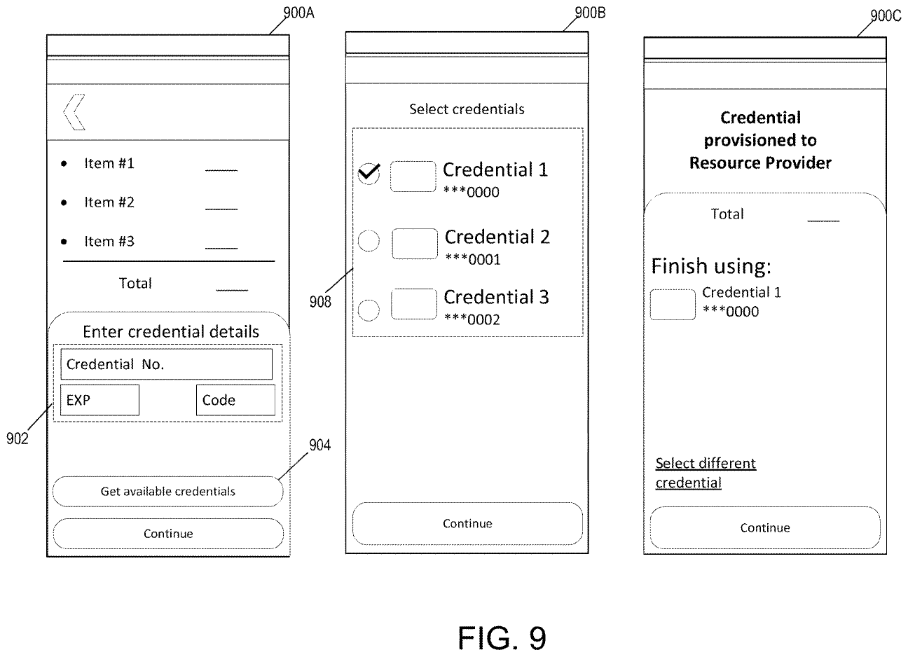

FIG. 9 provides illustrations of exemplary GUIs displayed by a user device 106 during a process for pull provisioning a token to a resource provider computer 110. GUIS 900A-900C may be displayed via an output device 106E of the user device 106. GUIs 900A-900C may be generated and displayed by the resource provider application 118 stored on the user device 106.

GUI 900A can be displayed by the user device 106 as part of a transaction process facilitated by the resource provider application 118 between the user and the resource provider. To complete the transaction, the user can be prompted to enter credential information via a set of input fields 902. The user can enter the requested information and choose to continue to complete the transaction using the input credential information. Alternatively, the user can select option 904 to retrieve credentials that are capable of being pull provisioned to the resource provider computer 110 for use in completing the transaction.

In response to the selection of option 904 by the user, the intermediate computer 108 or the resource provider computer 110 can interact with the server computer 102 to retrieve a set of credentials associated with the user and accepted by the resource provider (e.g., based on whether the resource provider accepts credentials issued by a particular authorizing entity). The listing of the set of credentials can be displayed to the user via the resource provider application 118 in GUI 900B. GUI 900B can display a selectable list 908 that lists the credentials available to the user for provisioning to the resource provider computer 110. In some embodiments, the resource provider application 118 can be configured to prompt the user to enter authentication information, such as an OTP, biometric information, or a password, before the list of credentials is provided to the user.

The user can select a credential to continue the pull provisioning process. In response to the selection, the intermediate computer 108, or, in some embodiments, the resource provider computer 110, can interact with the server computer 102 and the token service 112 to complete the pull provisioning process (e.g., process 700 described with respect to FIG. 7). Once the token associated with the selected credential is obtained and provisioned to the resource provider computer 110, the resource provider application 118 can display GUI 900C to prompt the user to complete the transaction using the provisioned credential. Once the user selects to continue the transaction with the provisioned credential, the resource provider computer 110 can use the provisioned token associated with the credential to complete the transaction.

Disclosed embodiments provide several advantages over current systems and methods for completing transactions between entities. For example, disclosed systems and methods provide a frictionless and efficient user experience in provisioning credentials for use by a resource provider. In conventional methods, if a user wishes to provision a resource provider with a credential such as an account number, the user would need to manually register each credential that they have with each resource provider. For example, if the user has two credentials with an issuer (e.g., a credit card number and a debit card number), and wishes to provision those credentials to three resource providers, then the user would have to perform six registration steps. In contrast, embodiments of the invention can provision the two credentials to all three resource providers in a single provisioning process. The user can provision credentials prior to interacting with a resource provider, such that the credentials are readily available when the user does transact with the resource provider. Further, disclosed systems and methods provide secure provisioning of tokens through the use of the credential reference identifier, which is a non-sensitive credential reference. The credential reference identifiers are linked to real credentials, which are sensitive data that are ideally not exposed to hackers and man-in-the-middle actors.

In addition, disclosed embodiments allow for seamless integration of multiple resource providers and service providers. The API 120 and the routing database 114C, which may use webhook functionality to facilitate interactions between the server computer 102 and the resource provider computer 110, allows integration of new resource providers with little overhead required by the resource provider. Thus, resource providers may be efficiently added or removed from the provisioning system.

Other embodiments of the invention are also contemplated.

In one embodiment a method can include receiving, by an intermediate computer, a provisioning instruction message including resource provider identifiers and credential reference identifiers associated with set of credentials. The provisioning instruction message can be generated by a server computer in response to a user requesting to provision a set of credentials to resource providers. The method can further include transmitting, from the intermediate computer to a token service computer, one or more token request messages including the credential reference identifiers. The method can also include receiving, by the intermediate computer, tokens corresponding to the credential reference identifiers, and provisioning, by the intermediate computer, the tokens to the resource providers associated with the resource provider identifiers.

In one embodiment a method can include receiving, by an intermediate computer from a resource provider computer, a pull provisioning request including a user identifier. The method can also include transmitting, from the intermediate computer to a server computer, the pull provisioning request, where the server computer is configured to retrieve a set of credentials associated with the user identifier. The method can include receiving, at the intermediate computer, the set of credentials. In some embodiments, the method can include transmitting, from the intermediate computer to a user device, an authentication message configured to prompt a user of the user device to authenticate their identity. Upon successful authentication, the method can further include transmitting, by the intermediate computer to the user device, a message including the set of credentials, where the user device is configured to display the set of credentials via an interface of the user device. The method also includes receiving, by the intermediate computer from the user device, a responsive message including a subset of credentials selected from the set of credentials by a user. The method further includes transmitting, from the intermediate computer to a token service computer, one or more token request messages including credential reference identifiers associated with the subset of credentials. The method can also include receiving, by the intermediate computer, tokens corresponding to the credential reference identifiers, and provisioning, by the intermediate computer, the tokens to the resource provider computer.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer from an authorizing entity computer, a provisioning request message comprising resource provider identifiers for a set of resource providers and a set of credentials to be associated with the set of resource providers; and
transmitting, by the server computer, a provisioning instruction message comprising the resource provider identifiers and credential reference identifiers associated with the set of credentials to an intermediate computer, wherein the intermediate computer transmits one or more token request messages comprising the credential reference identifiers to a token service computer, receives tokens corresponding to the credential reference identifiers, and provisions the tokens to the resource providers associated with the resource provider identifiers.

2. The method of claim 1, wherein the method further comprises:
receiving, by the server computer, the provisioned tokens;
retrieving, by the server computer from a routing database, address information associated with the set of resource providers; and
transmitting, by the server computer, the provisioned tokens to a set of resource provider computers associated with the set of resource providers based on the address information associated with the set of resource providers.

3. The method of claim 2, wherein the routing database stores a plurality of webhooks associated with a plurality of resource providers, and wherein the plurality of webhooks are based on resource provider connection details and define addresses of the plurality of resource providers.

4. The method of claim 1, wherein the method further comprises:
asynchronously recording, by the server computer in a provisioning database, a provisioning record comprising the set of credentials.

5. The method of claim 4, wherein the method further comprises:
updating, by the server computer, the provisioning record in the provisioning database based on a token provisioning result.

6. The method of claim 1, wherein the provisioning request message is received by the server computer in response to a provisioning request being received by the authorizing entity computer from a user device.

7. The method of claim 1, wherein the method further comprises:
verifying, by the server computer, enrollment statuses of the set of resource providers based on the resource provider identifiers.

8. The method of claim 7, wherein the method further comprises:
determining, by the server computer, that a first resource provider of the set of resource providers is not enrolled; and
transmitting, by the server computer to the authorizing entity computer, an error message comprising an enrollment status of the first resource provider.

9. The method of claim 1, wherein the method further comprises:
parsing, by the server computer, the provisioning request message to determine a template data format; and
routing the provisioning request message, via an API of the server computer, to an enrollment service of the server computer based on the template data format.

10. The method of claim 1, wherein the method further comprises:
receiving, from the intermediate computer, an onboarding request message comprising the resource provider identifiers for the set of resource providers;
onboarding, by the server computer, the set of resource providers by storing, in a configuration database, the set of resource provider identifiers.

11. A server computer comprising;
a processor; and
a computer-readable medium coupled to the processor, the computer-readable medium comprising code executable by the processor for implementing a method comprising:
receiving, from an authorizing entity computer, a provisioning request message comprising resource provider identifiers for a set of resource providers and a set of credentials to be associated with the set of resource providers; and
transmitting a provisioning instruction message comprising the resource provider identifiers and credential reference identifiers associated with the set of credentials to an intermediate computer, wherein the intermediate computer transmits one or more token request messages comprising the credential reference identifiers to a token service computer, receives tokens corresponding to the credential reference identifiers, and provisions the tokens to the resource providers associated with the resource provider identifiers.

12. The server computer of claim 11, wherein the method further comprises:
receiving the provisioned tokens;
retrieving, from a routing database, address information associated with the set of resource providers; and
transmitting the provisioned tokens to a set of resource provider computers associated with the set of resource providers based on the address information associated with the set of resource providers.

13. The server computer of claim 12, wherein the routing database stores a plurality of webhooks associated with a plurality of resource providers, and wherein the plurality of webhooks are based on resource provider connection details and define addresses of the plurality of resource providers.

14. The server computer of claim 11, wherein the method further comprises:
asynchronously recording, in a provisioning database, a provisioning record comprising the set of credentials.

15. The server computer of claim 14, wherein the method further comprises:
updating the provisioning record in the provisioning database based on a token provisioning result.

16. The server computer of claim 11, wherein the provisioning request message is received in response to a provisioning request being received by the authorizing entity computer from a user device.

17. The server computer of claim 11, wherein the method further comprises:
verifying, by the server computer, enrollment statuses of the set of resource providers based on the resource provider identifiers.

18. A method comprising:
receiving, by the server computer from an intermediate computer, a pull message comprising a credential provided by a user to a resource provider computer;
retrieving, by the server computer, a set of credential reference identifiers associated with the credential;
transmitting, by the server computer to the intermediate computer, the set of credential reference identifiers;
receiving, by the server computer, a selection of one or more of the credential reference identifiers; and
provisioning, by the server computer, tokens associated with the one or more credential reference identifiers for the resource provider computer.

19. The method of claim 18, wherein the set of credential reference identifiers are retrieved from a database storing credential reference identifiers associated with enrolled credentials.

20. The method of claim 19, wherein retrieving the set of credential reference identifiers comprises querying the database based on an authorizing entity identifier associated with the credential.
